(19) United States
(12) Patent Application Publication
(10) Pub. No.: US 2026/0359331 A1
(43) Pub. Date: Nov. 12, 2026

(54) GENERATIVE MODEL REASONING WITH DEBATE AND/OR TOURNAMENTS

(71) Applicant: GDM Holding LLC, Mountain View, CA (US)

(72) Inventors: Edward Grefenstette, London (GB); Zachary Kenton, London (GB); Samuel Mark Albanie, London (GB); Rishabh Agarwal, Montreal (CA); Jannis Bulian, Zurich (CH); Minqi Jiang, Oxfordshire (GB); Noah Goodman, London (GB)

(21) Appl. No.: 19/662,569

(22) Filed: Apr. 29, 2026

Related U.S. Application Data
(60) Provisional application No. 63/804,241, filed on May 12, 2025.

(51) Int. Cl. G06F 16/3329; G06N 3/092

(52) U.S. Cl. CPC G06F 16/33295; G06N 3/092

(57) ABSTRACT

Implementations are described herein for improving reasoning in generative models. In various implementations, a turn-based dialog may be implemented where a first prompt supporting a first position and a second prompt supporting a mutually exclusive second position are processed by one or more generative models. The generative models generate respective outputs, and after a termination condition is met, a transcript of the dialog is used to determine an outcome indicating which position prevailed. Based on this outcome, the generative models may be trained, and/or other actions may be taken if the techniques are practiced during inference.

### BACKGROUND

In the realm of generative models, such as single-modal or multimodal large language models (LLMs), vision-language models (VLMs), etc., significant advancements have enabled impressive performance across diverse tasks.

### SUMMARY

Various challenges remain in relation to the robustness and reliability of these models' reasoning capabilities. While generative models can generate seemingly coherent and logical outputs, they often exhibit brittleness, particularly when confronted with adversarial examples or subtle logical nuances. This sensitivity raises concerns about the ability of generative models to generalize and consistently provide accurate solutions.

Existing approaches to improve generative model reasoning often focus on techniques such as Chain-of-Thought (CoT) prompting, which encourages the model to generate intermediate reasoning steps. Another common technique is Best-of-N (BoN) sampling, where multiple candidate solutions are generated, and the one with the highest score (according to a reward model or other criteria) is selected. Self-consistency methods, like weighted majority voting, aim to improve reliability by selecting the most consistent answer across multiple generations.

Despite the progress made by these methods, a number of limitations persist. The fragility of generative model reasoning limits their robustness and impairs their generalization to unseen tasks. Generative models may rely on superficial pattern matching rather than robust reasoning. Verifying the correctness of generative model-created solutions without external feedback remains challenging. Therefore, there exists a need for new and improved approaches to promote robust reasoning capabilities in generative models.

Some implementations disclosed herein are directed to using self-debate to train and/or fine-tune generative models. This may include implementing a turn-based dialog between two or more “debaters” until a termination condition is satisfied, including assembling a first prompt to generate first output supporting a first position and assembling a second prompt to generate second output supporting a second position. The first and second prompts may also include prior outputs, if present, and the first and second positions may be mutually exclusive and/or contradictory. The first and second prompts are processed using one or more generative models to generate the first and second outputs. After the termination condition is satisfied, a transcript of the turn-based dialog may be used, e.g., by a “judge,” to determine an outcome that indicates whether the first or second position prevailed, and one or more of the generative models are trained based on the outcome.

These implementations may mitigate (e.g., eliminate) various drawbacks with current techniques. For example, rather than relying on superficial pattern matching, self-play debate compels the models to engage in more robust reasoning by identifying weaknesses in their own arguments and anticipating counterarguments. As another example, because the generative models are trained to act as both debaters and judges, the disclosed implementations can provide more comprehensive justifications for their claims and conclusions, fostering improved transparency of LLM reasoning. As another example, by training on a diverse set of tasks and debate formats, the disclosed implementations can generalize to unseen reasoning tasks with greater flexibility and adaptability.

As a non-limiting example of some implementations disclosed herein, consider a scenario where the method is used to enhance the reasoning capabilities of a generative model in the domain of medical diagnosis. A patient presents with a set of symptoms, and the task is to determine the most likely diagnosis. The method initiates a turn-based dialog, where a first instance of a generative model is applied to a first prompt to generate a first output that supports a first diagnosis (e.g., “The patient's symptoms strongly suggest pneumonia”). A second instance of the same generative model (or a different generative model) is applied to a second prompt to generate a second output supporting a second, mutually exclusive diagnosis (e.g., “The patient's symptoms are more indicative of bronchitis”). These prompts incorporate the initial patient information as well as any prior outputs from the ongoing dialog. The generative models then process these prompts, generating their respective outputs, which include justifications and supporting evidence for their chosen diagnoses.

This exchange continues iteratively, with each instance of the generative model building upon the previous outputs and attempting to refute the opposing argument. The termination condition might be a predetermined number of turns or the identification of semantic consistency between consecutive statements. Finally, the method uses a transcript of the dialog to determine the outcome, either by having a judge model evaluate the arguments presented or by comparing the final diagnoses with ground truth data (if available). Based on this outcome, the generative models are trained to improve their ability to formulate persuasive arguments and identify logical weaknesses in opposing viewpoints, leading to more accurate and reliable diagnostic reasoning.

In a related aspect, some implementations disclosed herein are directed to initiating a back-and-forth dialog where one or more generative models are prompted to generate statements supporting a first position related to a topic. This may also involve generating responsive statements supporting a second position that is mutually exclusive from the first position. The back-and-forth dialog may continue until a termination condition is satisfied (e.g., maximum number of turns, consecutive statements that are aligned semantically/semantically consistent), including prompting one or more of the generative models with prior natural language statements of the back-and-forth dialog to generate subsequent statements related to the topic. A transcript of the back-and-forth dialog is evaluated to determine an outcome. One or more of the generative models are trained based on the outcome.

These additional implementations can mitigate (e.g., eliminate) various drawbacks with current techniques. For example, rather than halting the dialog based solely on simple criteria, the disclosed implementations may terminate the dialog based on detection of semantic consistency, potentially leading to more meaningful exchanges and a more accurate and reliable determination of the outcome. As another example, by incorporating ground truth data to evaluate the transcript and train the generative models, the disclosed implementations can provide a mechanism for ensuring the accuracy and relevance of the generated content. As another example, the use of reinforcement learning and reward signals based on the outcome of the dialog allows the models to adapt and improve their reasoning and argumentation skills over time.

In yet another aspect, various implementations disclosed herein are directed to processing an input prompt using one or more generative models, which then generates a plurality of candidate responses. The implementations perform two or more iterations of pairwise comparisons between the candidate responses using a comparator process. Based on the pairwise comparisons, one of the candidate responses is selected for provision to a downstream process. The plurality of candidate responses can be natural language statements. The iterations of pairwise comparisons can be implemented as a single elimination tournament, as a plurality of tournaments, as a round-robin process, or as a tournament having a predefined number of rounds. During each round, the plurality of candidate responses are paired using a pairing mechanism, such as top-bottom pairing in a first round and subsequent pairings based on performance in the first round (e.g., a Swiss-style tournament). The comparator process can be a reward model trained to predict correctness, or it can be a generative model or a zero-shot comparator or a reinforcement learning fine-tuned comparator.

These additional implementations can also mitigate (e.g., eliminate) drawbacks with current techniques for selecting the best reasoning sample. For example, rather than relying solely on a single “best” response as determined by a reward model, performing multiple iterations of pairwise comparisons enables a more nuanced evaluation of the candidate responses, potentially leading to a more accurate selection. As another example, by implementing the pairwise comparisons as a tournament, the disclosed implementations can systematically compare and filter candidate responses, increasing the likelihood of identifying the most accurate and coherent solution. As another example, using a comparator process that is itself a generative model trained to generate comparison results, the disclosed implementations can leverage the power of large language models to perform sophisticated reasoning about the relative merits of different candidate responses.

In various implementations, a method may be implemented using one or more processors and may include implementing a turn-based dialog until a termination condition is satisfied. This may involve, at each turn, assembling a first prompt that includes one or more prior outputs of the turn-based dialog, if present, and a command to generate first output supporting a first position in relation to a discourse. The method may also include causing the first prompt to be processed using one or more generative models to generate the first output. A second prompt may also be assembled to include one or more prior outputs of the turn-based dialog, if present, and a command to generate second output supporting a second position in relation to the discourse, where the first and second positions may be mutually exclusive. The second prompt may be processed using one or more of the generative models to generate the second output. Upon determining that the termination condition is satisfied, a transcript of the turn-based dialog may be used to determine an outcome of the turn-based dialog, where the outcome may indicate whether the first or second position prevailed. Based on the outcome, one or more of the generative models may be adapted.

In various implementations, the first and second positions may include natural language propositions. In various implementations, the outcome may be determined by processing the transcript using one or more of the generative models to generate judgement output that identifies the first or second position as having prevailed. In various implementations, the one or more generative models may include a single generative model. In various implementations, different generative models may be used to generate output supporting the first and second positions. In various implementations, the outcome may be determined based on ground truth Boolean values of the first and second positions. In various implementations, the termination condition may include a maximum number of dialog turns.

In various implementations, the adapting may include assembling a training corpus of discourse scenarios, where each discourse scenario may include a first position, a second position that is mutually exclusive from the first position, and an indication of whether the first or second position is true. For each discourse scenario in the training corpus, a turn-based dialog, as previously described, may be performed, and a training loss may be calculated for one or more of the generative models based on a comparison between the outcome of the turn-based dialog and the indication of whether the first or second position is true.

In various implementations, the adapting may further include adjusting parameters of one or more of the generative models to reduce the training loss. In various implementations, the first and second positions may relate to a problem-solving task that may be selected from the group including logical reasoning, mathematics, and coding. In various implementations, a method may employ a reinforcement learning technique that utilizes a reward signal, where the reward signal may be determined by an agreement between the outcome of the turn-based dialog and an indication of ground truth.

In various implementations, a training objective may be used, where the training objective may include rewarding one or more of the generative models for maximizing a value y, where maximizing the value y may be indicative of the first position having prevailed; rewarding one or more of the generative models for maximizing a value 1−y, where maximizing the value 1−y may be indicative of the second position having prevailed; and rewarding one or more of the generative models for minimizing an absolute difference value between the outcome and ŷ.

In various implementations, a method may be implemented using one or more processors and may include initiating a back-and-forth dialog in which one or more generative models are prompted to generate one or more natural language statements supporting a first position in relation to a topic and one or more responsive natural language statements supporting a second position that may be mutually exclusive semantically from the first position. The back-and-forth dialog may be continued until a termination condition is satisfied, including prompting one or more of the generative models with prior natural language statements of the back-and-forth dialog to generate one or more subsequent statements related to the topic. A transcript of the back-and-forth dialog may be evaluated to determine an outcome, and one or more of the generative models may be adapted based on the outcome.

In various implementations, the termination condition may include detection of semantic consistency between consecutive statements of the back-and-forth dialog. In various implementations, the termination condition may include the back-and-forth dialog reaching a maximum number of turns.

In various implementations, the outcome may be determined based on a comparison of the transcript with ground truth data about the topic. In various implementations, the outcome may include semantic consistency between consecutive statements of the back and forth dialog. In various implementations, the adapting may include rewarding one or more of the generative models based on the semantic consistency.

In various implementations, the one or more generative models may include a single generative model. In various implementations, the one or more generative models may include a large language model (LLM). In various implementations, the LLM may include a multimodal LLM. In various implementations, the one or more generative models may include a vision-language model (VLM).

In another aspect, a method may be implemented using one or more processors and may include processing an input prompt using one or more generative models to generate a plurality of candidate responses. Two or more iterations of pairwise comparisons between candidate responses of the plurality of candidate responses may be performed using a comparator process. Based on the pairwise comparisons, one of the candidate responses may be selected for provision to a downstream process. In various implementations, the plurality of candidate responses may include natural language statements. In various implementations, the iterations of pairwise comparisons may be implemented as a single elimination tournament. In various implementations, the iterations of pairwise comparisons may be implemented as a plurality of tournaments. In various implementations, the iterations of pairwise comparisons may be implemented as a round-robin process.

In various implementations, the iterations of pairwise comparisons may be implemented as a tournament having a predefined number of rounds. In various implementations, the plurality of candidate responses may be paired during each round using a pairing mechanism. In various implementations, the pairing mechanism may use top-bottom pairing in a first round of the predefined number of rounds. In various implementations, the pairing mechanism may pair candidate responses in one or more subsequent rounds based on the performance of the candidate responses in the first round. In various implementations, the one or more iterations of pairwise comparisons may be implemented as a Swiss-style tournament.

In various implementations, the comparator process may include a reward model. In various implementations, the reward model may be trained to predict whether individual candidate responses are correct. In various implementations, the reward model may include a neural network. In various implementations, the reward model may be trained using non-contrastive examples. In various implementations, the comparator process may include a generative model trained to generate comparison results. In various implementations, the comparator process may include a zero-shot comparator. In various implementations, the comparator process may include a reinforcement learning (RL) fine-tuned comparator. In various implementations, the downstream process may include a training process for training one or more of the generative models.

In another aspect, a method may be implemented using one or more processors and may include implementing a turn-based dialog until a termination condition is satisfied. This may involve, at each turn, assembling a first prompt that includes one or more prior outputs of the turn-based dialog, if present, and a command to generate first output supporting a first position in relation to a discourse. The method may also include causing the first prompt to be processed using one or more generative models to generate the first output. A second prompt may also be assembled to include one or more prior outputs of the turn-based dialog, if present, and a command to generate second output supporting a second position in relation to the discourse, where the first and second positions may be mutually exclusive. The second prompt may be processed using one or more of the generative models to generate the second output. Upon determining that the termination condition is satisfied, a transcript of the turn-based dialog may be used to determine an outcome of the turn-based dialog, where the outcome may indicate whether the first or second position prevailed. Based on the outcome, a robot control signal may be generated.

In various implementations, the method may further include operating a real or simulated robot using the robot control signal.

In another aspect, a method may be implemented using one or more processors and may include initiating a back-and-forth dialog in which one or more generative models are prompted to generate one or more natural language statements supporting a first position in relation to a topic and one or more responsive natural language statements supporting a second position that may be mutually exclusive semantically from the first position. The back-and-forth dialog may be continued until a termination condition is satisfied, including prompting one or more of the generative models with prior natural language statements of the back-and-forth dialog to generate one or more subsequent statements related to the topic. A transcript of the back-and-forth dialog may be evaluated to determine an outcome, and a robot control signal may be generated based on the outcome. In various implementations, the method may further include operating a real or simulated robot using the robot control signal.

While examples described herein relate to using self-debate to improve generative models, e.g., during training or fine-tuning, the present disclosure is not so limited. For example, self-debate may be employed during inference time to generate output that contains an optimal decision in a particular context. For example, a robot may be controlled by an AI-based processing pipeline that includes a “world” model (e.g., a foundational model such as the generative models described herein) that predicts which actions the robot should take to complete a task, as well as additional model(s) that generate actual robot control data (e.g., joint commands, reward function code, etc.). In various implementations, when the robot is asked to perform a task (e.g., “clear everything off the table and take dishes to the sink”), the world model may be prompted to engage in self debate by taking opposing views on how the task is to be performed. The transcript of this self-debate and/or cooperation between the two debaters may be used to select a “best” strategy for the robot to carry out the task.

### BRIEF DESCRIPTION OF THE DRAWINGS

FIG. 1 illustrates an example environment showing various components such as a knowledge system, client device, and networks.

FIG. 2A shows an example output from a first debater presenting an argument supporting a proposition in an adversarial debate.

FIG. 2B shows an example output from a second debater arguing against the proposition supported by the first debater in the adversarial debate.

FIG. 3 shows an example output from a judge evaluating the arguments made by first and second debaters.

FIG. 4A shows an example output from a first debater presenting an argument supporting a proposition in a first round of a cooperative debate.

FIG. 4B shows an example output from a second debater arguing against the proposition supported by the first debater in the first round of the cooperative debate.

FIG. 5A shows an example output from the first debater in a second round of the cooperative debate.

FIG. 5B shows an example output from the second debater being persuaded to align with the first debater's position in the second round of the cooperative debate.

FIG. 6 depicts a flowchart illustrating an example method for training one or more generative models using a turn-based dialog.

FIG. 7 depicts another flowchart illustrating an example method for training one or more generative models using a back-and-forth dialog.

FIG. 8 depicts another flowchart illustrating an example method for selecting from multiple candidate generative model responses using various types of tournaments.

FIG. 9 is a block diagram of an example computer system.

### DETAILED DESCRIPTION

This specification relates to processing data using machine learning models. Machine learning models receive an input and generate an output, e.g., a predicted output, based on the received input. Some machine learning models are parametric models and generate the output based on the received input and on values of the parameters of the model. Some machine learning models are deep models that employ multiple layers of models to generate an output for a received input. For example, a deep neural network is a deep machine learning model that includes an output layer and one or more hidden layers that each apply a non-linear transformation to a received input to generate an output.

Techniques are described herein for training generative models such as LLMs or VLMs to engage in self-play debate to enhance their reasoning capabilities. These debates may be implemented in various formats: adversarial debate, where one or more generative models are used to generate opposing positions of a proposition before committing to a judgement, and cooperative debate, where one or more generative models work collaboratively to identify the correct answer through iterative dialogue. By mimicking the dynamics of human argumentation, self-play debate as described herein may cause generative models to identify weaknesses in their own reasoning, anticipate potential counterarguments, and ultimately generate more robust and reliable chains of thought.

Techniques described herein focus on directly training the debaters (e.g., agents taking mutually exclusive and/or contradictory positions in relation to a discourse, multiple instantiations of the same generative model, etc.) to improve their reasoning capabilities. External ground truth may be leveraged during training to guide the learning process and foster generalization, in contrast to approaches that rely solely on self-critique or internal consistency.

One benefit of using generative-model-powered debate as described herein is the ability to expose weaknesses in arguments. A counter to an incorrect argument can point out a specific weakness, and the remainder of the debate can focus on identifying the specific incorrect step in the argument, both making the debate more effective and facilitating judgement. Debates also provide a structured framework for identifying and addressing weaknesses in reasoning. In an adversarial setting, an opposing generative model may be incentivized to expose flaws in the arguments presented by its counterpart generative model. In a cooperative setting, the need to reach a consensus may encourage both generative models (e.g., separate instances of the same model, opposing agents, etc.) to critically examine their own reasoning, identify potential points of disagreement and take on board strong points from their counterpart. This process of challenge and response can lead to a more refined and robust understanding of the problem at hand.

Moreover, the interactive nature of debate encourages generative models to generate more comprehensive and persuasive justifications for their claims. Rather than simply producing an answer, the generative models may articulate their reasoning step-by-step, anticipating potential challenges by the counterpart and providing evidence to support conclusions. This process of explicit justification may not only improve the transparency of generative model reasoning, but also may cause the models to engage more deeply with the underlying concepts.

Debate training may additionally promote generalization to unseen tasks by encouraging generative models to develop more general reasoning strategies that are more flexible and adaptable. The need to anticipate and respond to diverse arguments in a debate setting may force the generative models to move beyond simple pattern matching and learn more general principles of reasoning that can be applied to novel situations.

In various implementations, debates may be implemented as adversarial debates or cooperative debates. For adversarial debates, let D be a data-generating process from which an unbounded number of unique and diverse tuples (A, B, ŷ) can be generated, where the positions A and B are related and mutually exclusive natural language propositions (i.e. one is true if and only if the other is false, and thus one must be true), and the indicator ŷ is 1 if A is true, and 0 if B is true.

Let M_{θ} be an LLM parameterized by θ. Let M_{θ}(A) and M_{θ}(B) be shorthand for a version of M_{θ} prompted to argue for, respectively, positions A and B. Let J_{θ} be a version of M_{θ} prompted to examine two-party debate transcripts, and decide which party has won the debate. Let debate (M_{θ}(A), M_{θ}(B)) be a process by which M_{θ}(A) and M_{θ}(B) take turns arguing for their respective positions until some termination criterion (e.g. number of turns) is produced, and let the output of this process be a transcript T.

Let the judgement y:=J_{θ}(T)=J_{θ}(debate (M_{θ}(A), M_{θ}(B))) be 1 if the judge decides A won the debate, based on the transcript, and 0 if B won the debate. If probabilities are read straight from the judge instead, the measure may be expressed as P(y|J(T)). The goal may be to train, through self-play, M to be both a good truth-seeking debater, and a good judge. The different parties could be represented by different models, but there are several advantages to tying them together with the same model: (i) it aligns with the goal to improve the “thinking” capabilities of a single generative model; (ii) training a single model reduces the need of computational resources; and (iii) this is also the simplest approach.

The same generative model instance may be used to sequentially embody both debater roles (for positions A and B) and the judge role, receiving distinct rewards for each generation as described in the training objective. Thus, in various implementations, there may be various aspects to a training objective implemented with various techniques described herein. M_{θ}(A) may be rewarded by maximizing y, i.e. by convincing the judge that A is correct. M_{θ}(B) may be rewarded by maximizing 1−y, i.e. by convincing the judge that B is correct. J_{θ}(R) may be rewarded by minimizing |y−ŷ|, i.e. by making the right decision.

With cooperative debate, by contrast, the idea is to reward debaters for agreeing on the right answer. There is no judge in this setting. Let coop-debate (M_{θ}(A), M_{θ}(B)) be a process by which M_{θ}(A) and M_{θ}(B) take turns discussing their initial positions until some termination criterion (e.g. they reached agreement or “semantic alignment”, or the debate has exceeded a number of turns). The output of the cooperative debate is a tuple (y_{A}, y_{B})=coop-debate (M_{θ}(A), M_{θ}(B)), where y_{A}, y_{B} are the respective decisions of the debaters.

As before, in some implementations, the same generative model instance may sequentially embody both debater roles (for positions A and B), receiving distinct rewards for each generation. In various implementations, the training objective in the cooperative debate mode may be to let M_{θ}(A) and M_{θ}(B) be rewarded if y_{A}=y_{B}=ŷ, i.e. by agreeing on the correct answer. In some implementations, there may be no reward if either y_{A}≠y_{B} or y_{A}=y_{B}≠ŷ.

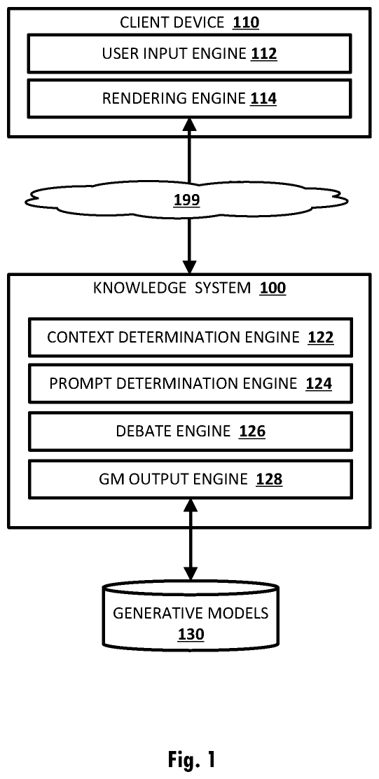

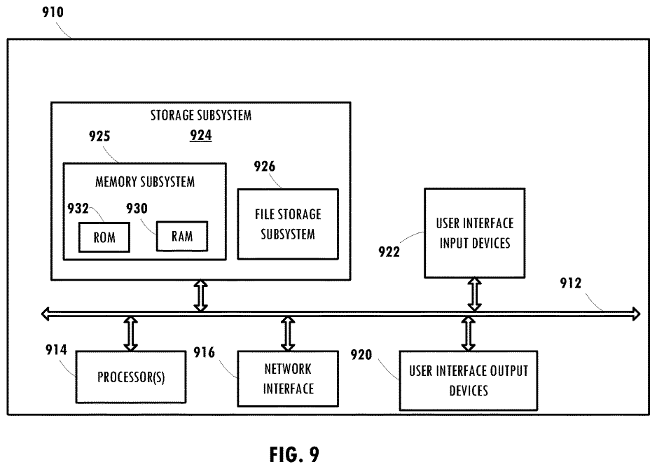

FIG. 1 schematically depicts an example environment in which selected aspects of the disclosure may be implemented. Any of the various components depicted in FIG. 1 may be implemented using any combination of hardware or software. For example, any of these components may be implemented as software modules that execute on one or more processors in one or more computer systems (e.g., the computer system(s) depicted in FIG. 9). As another example, any of these components may be implemented by one or more computer systems located in the same physical location, and/or by one or more computer systems in two or more physical locations. Similarly, any two or more of these components may be combined into a single apparatus, and the various functions described herein may be performed by the single apparatus or divided up among different apparatuses (e.g., in a distributed fashion).

A knowledge system 100 is depicted in FIG. 1 as an example of one of many suitable environments in which selected aspects of the present disclosure may be practiced. Knowledge system 100 may include various engines that may be implemented using any combination of hardware and software. In FIG. 1, for instance, knowledge system 100 includes a context determination engine 122, a prompt determination engine 124, a debate engine 126, a GM output engine 128, and a generative model(s) 130. Knowledge system 100 may additionally include any other components not depicted in FIG. 1.

Client device 110 may take various forms. These may include, but are not limited to, mobile devices that include one or more processors and one or more memories (e.g., smartphones, tablet computers, wearable devices, etc.), personal computers (PCs), etc. Client device 110 includes a user input engine 112 that allows a user of client device 110 to provide various inputs to client device 110 (e.g., by typing into one or more input fields). Client device 110 also includes a rendering engine 114 that allows client device 110 to render various types of content (e.g., text, graphics, video, audio, and/or any combination thereof) for presentation to a user of client device 110. This content may be rendered, for example, on a screen of client device 110. In some cases, the content may be interactive and may provide the ability for a user to provide input via client device 110 (e.g., via a touchscreen display, via a mouse or other pointing device, etc.).

Context determination engine 122 may be configured to determine one or more contexts of one or more knowledge requests received by knowledge system 100. The knowledge requests may be received via network(s) 199. Additionally or alternatively, some or all of the knowledge requests may be generated automatically at knowledge system 100. The contexts may be determined in a variety of ways. In some implementations, the contexts of knowledge requests may be automatically determined based on attributes of the knowledge requests and/or information included in the knowledge requests themselves. For example, the attributes of a knowledge request may include one or more of: the source (e.g., an Internet domain, an Internet service provider, an IP address, a user, etc.) of the knowledge request, one or more keywords or phrases in a resource (e.g., a web page, a document, etc.) referenced in the knowledge request, information about a user and/or a client device (e.g., client device 110) that issued the knowledge request, etc. The context of a knowledge request may be determined based on one or more of these attributes (e.g., by combining multiple attributes). Information included in a knowledge request may include, for instance: one or more keywords or phrases in a resource referenced in the knowledge request, content of a resource referenced in the knowledge request, a source of the resource, a content type of a resource referenced in the knowledge request, and so forth.

Prompt determination engine 124 may be configured to determine how to generate an initial prompt based on the context of a knowledge request received by knowledge system 100. Prompt determination engine 124 may determine the initial prompt based on information included in the knowledge request, based on information about a user and/or client device that issued the knowledge request, based on one or more contexts of the knowledge request, based on one or more contexts determined by context determination engine 122, based on one or more attributes of the knowledge request, based on one or more attributes determined by context determination engine 122, based on one or more attributes of a resource referenced in the knowledge request, and/or based on any other technique or information. For example, prompt determination engine 124 may determine how to generate an initial prompt based on a context determined by context determination engine 122, or based on a content type of a resource referenced in the knowledge request.

Debate engine 124 may be configured to cooperate with other components of knowledge system 100, such as context determination engine 122, prompt determination engine 124, and/or GM output engine 128, to use one or more generative models to implement a turn-based dialog between two “debaters.” These debaters may be software-implemented agents and/or may be constructs that represent debaters. In some implementations, each debater may use a separate generative model. In other implementations, the debaters may be implemented using the same or separate instances of the same generative model.

Debate engine 126 may be configured to manage the generation of prompts that guide generative model(s) 130 through multiple turns of a dialog, where the generative models advocate for opposing positions. The first prompt may include prior outputs from the dialog, if any, and a request for output supporting a first position in relation to a topic. The generative model(s) 130 may then generate output relevant to that first position. A second prompt is then constructed, which again may include prior dialog history, but this time the prompt includes a command to generate output supporting a second position that is mutually exclusive with the first. The process is repeated until a defined termination condition is met, such as reaching a maximum number of turns or achieving semantic consistency between turns. Dependent on which type of debate is occurring, this may happen via debate engine 126 enabling one or more generative models to take turns discussing their positions until agreement or until some other specified termination criterion is satisfied. After completion of the back-and-forth, debate engine 126 may determine the outcome of the debate, leveraging generative model(s) 130 as a judge, or relying on ground truth data if available. This outcome can then be used, e.g., by knowledge system 100, to train the generative model(s) 130 to improve reasoning and argumentation skills.

GM output engine 128 may be configured to use generative model(s) 130, in whole or in part, to generate information to respond to requests received by knowledge system 100, including debate engine 126. In some implementations, GM output engine 128 can oversee the process of producing several candidate responses to a specific prompt by leveraging generative model(s) 130. Subsequently, a series of pairwise comparisons may be performed on the candidate responses using a comparator process, which itself may involve generative model(s) 130, reward models or other types of comparators to make its comparison. The pairwise comparisons may be implemented as single-elimination, multi-tournament, round-robin or other forms of tournament. Based on these comparisons, the GM output engine 128 selects the most suitable response. This chosen response can then be passed on to other components of knowledge system 100 for training or additional actions.

Generative model(s) 130 may take various forms, such as a single-modal or multimodal large language model (LLM), vision-language model (VLM), and/or other type of generative model. Generative model(s) 130 may have various types of architectures, such as encoder only, encoder-decoder, decoder-only, etc. In some implementations, generative model(s) 130 may include diffusion model(s). Non-limiting examples of generative models may include, but are not limited to, Gemini, Gemini 2.0, Flamingo, and so forth. Generative models may have hundreds of millions, if not hundreds of billions, of parameters.

Generative models executed on the cloud can leverage significantly larger computational resources and datasets compared to those on a local device. This allows cloud-based models to be trained with many more parameters, leading to a greater capacity for learning complex patterns and relationships in the training data. Consequently, cloud-based generative models may exhibit superior performance and generate more realistic or diverse outputs than their locally executed counterparts. On the other hand, smaller generative models, particularly those hosted locally on a client device, may offer enhanced privacy due to on-device data processing, reduced latency because they eliminate network transit time, and improved accessibility even without continuous network connectivity. Furthermore, running models locally can decrease reliance on centralized cloud infrastructure, offering greater control and potentially lower operational costs.

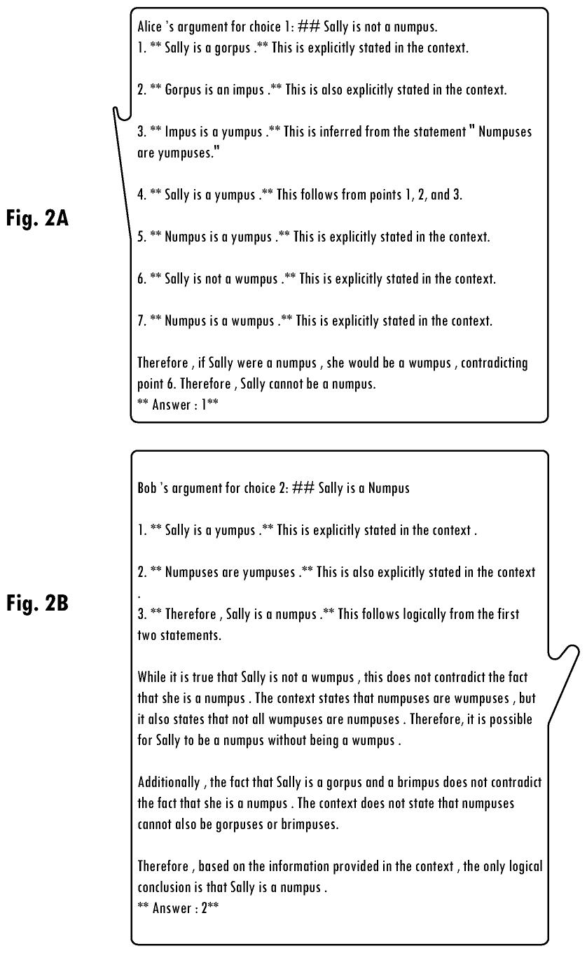

FIGS. 2A and 2B depict examples the type of output that may be generated by a first debater named “Alice” (e.g., agent, construct) and a second debater named “Bob” in an adversarial debate. To generate these outputs, generative model(s) 130 may be prompted, by or on behalf of debaters “Alice” and “Bob,” with context that provides various ground truth facts. For example, a prompt such as the following may be processed on behalf of each debater, e.g., using frameworks such as the Proof and Ontology-Generated Question Answering (PRONTOQA) synthetic dataset described in “Language Models are Greedy Reasoners: A Systematic Formal Analysis of Chain-of-Thought” (arXiv:2210.01240):

{ PREMISES }
Which of the option logically follows ?
Pick one of the following choices :
Answer 1: { CONCLUSION_1 }
Answer 2: { CONCLUSION_2 }
Explain your reasoning step by step
before you answer . \
Finally state your answer formatted as
\“ Answer : < 1|2 >\”. \

In this scenario, the context (or {PREMISES} in the above prompt) includes the following ground truth/explicitly provided facts: (i) Sally is a gorpus; (ii) a gorpus is an impus; (iii) a numpus is a yumpus; and (iv) Sally is not a wumpus. Additionally, Alice is prompted to take the position that Sally is not a wumpus, while Bob is prompted to take the contradictory and/or mutually exclusive position that Sally is a wumpus.

Using these facts, Alice presents a logical argument to demonstrate that Sally is not a numpus. Her argument proceeds through a series of steps based on information explicitly provided and inferred from the context. First, she states that Sally is a gorpus, a fact directly stated in the context. She then notes that a gorpus is an impus, which is also explicitly stated. Next, she infers that an impus is a yumpus from the statement “Numpuses are yumpuses.” From these points, Alice concludes that Sally is a yumpus.

Continuing her reasoning, Alice points out that numpuses are yumpuses (explicitly stated) and that Sally is not a wumpus (also explicitly stated). Additionally, she notes that a numpus is a wumpus (explicitly stated). Alice then synthesizes these facts to arrive at her final conclusion. Alice reasons that if Sally were a numpus, then she would also be a wumpus. However, the context states that Sally is not a wumpus. This contradiction leads Alice to conclude that Sally cannot be a numpus. Therefore, based on this deductive reasoning, Alice answers that Sally is not a numpus.

Referring to FIG. 2B, and using the same facts, Bob presents a logical argument to demonstrate that Sally is a numpus. Bob comes to the conclusion that Sally is a numpus by following a different line of reasoning. He begins by noting that the context explicitly states that Sally is a yumpus and that numpuses are yumpuses. From these two premises, Bob infers that Sally must be a numpus, as it logically follows from these statements.

Bob then addresses the apparent contradiction that Sally is not a wumpus, arguing that this does not preclude her from being a numpus. He explains that while numpuses are wumpuses, the context also specifies that not all wumpuses are numpuses. Therefore, Sally could be a numpus without necessarily being a wumpus. Bob further clarifies that the fact that Sally is also a gorpus and a brimpus does not contradict her being a numpus, as the context does not prohibit numpuses from also being gorpuses or brimpuses. Based on this reasoning, Bob concludes that the only logical conclusion is that Sally is a numpus.

In some implementations, a judge may be implemented in a similar fashion as the first and second debaters. The judge may be an agent or may be an instance in which the same generative model as was used by/on behalf of the two debaters, or a different generative model, is prompted with the outputs generated by the two debaters (in this example, the outputs of FIGS. 2A-B), the same underlying context (e.g., the ground truth statements), and an instruction to determine which debater prevailed. In some implementations a comparator process may be employed, such as a comparator model or a zero-shot comparator model.

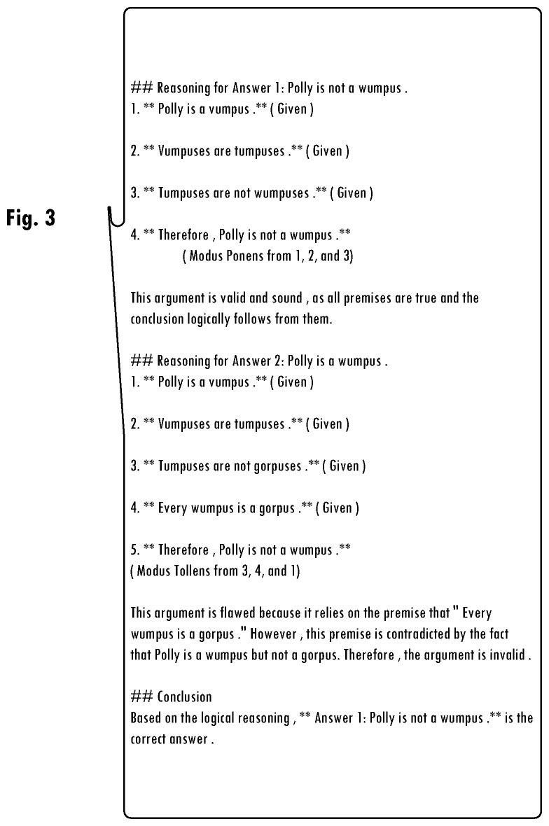

FIG. 3 illustrates an example of the kind of output that may be generated by a judge, possibly implemented as an agent or using the same generative model as the debaters, when evaluating a debate between two debaters about whether Polly is a wumpus. In this instance, one debater presented reasoning supporting the conclusion that Polly is not a wumpus, while the opposing debater argued that Polly is, in fact, a wumpus.

The reasoning for the conclusion that “Polly is not a wumpus” is based on the premises that Polly is a vumpus, vumpuses are tumpuses, and tumpuses are not wumpuses. This applies the form of argument where if statement A is true, and A implies B, then B must be true. Applied to the described scenario, since Polly is a vumpus and vumpuses are tumpuses, then Polly is a tumpus. This step in the reasoning leads to the valid and sound conclusion that Polly is not a wumpus, as all the premises are assumed to be true and the conclusion follows logically. Conversely, the reasoning for the conclusion that “Polly is a wumpus” begins with the same first two premises (Polly is a vumpus and vumpuses are tumpuses) but introduces the premises that tumpuses are not gorpuses, and that every wumpus is a gorpus. This leads to the conclusion that Polly is not a wumpus based on Modus Tollens.

The argument that “Polly is a wumpus” is deemed invalid because it relies on the premise that “Every wumpus is a gorpus,” which is contradicted by the initial assertion that Polly is a wumpus but not a gorpus. Therefore, based on logical reasoning, the argument that “Polly is not a wumpus” is the correct answer because its premises are all consistent and lead to a sound conclusion.

As shown in these examples, debate engine 126 may orchestrate a structured dialogue between different generative model instances, or agents, each representing a distinct viewpoint on a given proposition. This structured dialogue compels the debaters (agents or instances of generative models) to delve deeper into the reasoning behind their positions. Debate engine 126 may prompt one debater to formulate and present an output supporting the initial claim. The subsequent turns might involve another debater presenting a counter-argument. Debate engine 126 may then provide another opportunity for the first debater to refute the second debater's counter-argument, ensuring a rigorous exploration of both positions. After a defined number of exchanges, or when another termination condition is met, a judgment is rendered (as shown in FIG. 3) to assess which position prevailed.

To train a generative model using the adversarial debates depicted in FIGS. 2A, 2B, and 3, in some implementations, multiple instances of the same generative model may be used: one for each debater (Alice and Bob) and one for the judge. Each debater instance may be prompted to generate arguments supporting their assigned position, as illustrated in FIGS. 2A and 2B. The judge instance, as depicted in FIG. 3, receives the debate transcript and is prompted to determine the winner. A loss function is then constructed to optimize the performance of each instance.

The instance of the generative model associated with the winning debater (determined by the judge) is rewarded, while the instance associated with the losing debater is not. The judge instance is rewarded when it correctly determines the winner, for example, because the winner's conclusion aligns with ground truth ŷ. This reward mechanism can be implemented using reinforcement learning techniques. For instance, the reward signal could be used to update the parameters of the generative models through policy gradient methods, encouraging them to generate more persuasive and accurate arguments.

In addition to adversarial debates, in some implementations, debate engine 126 may orchestrate cooperate debates where two debaters (e.g., agents, instances of generative model(s) being prompted) initially take contradictory and/or mutually exclusive positions, but then attempt to find a common ground. In various implementations, these back-and-forth turn-based debates may continue until some termination condition is satisfied, such as a predetermined number of turns or detection of semantic consistency between turns. In cooperative debates, the generative model(s) may be rewarded for converging on the correct answer.

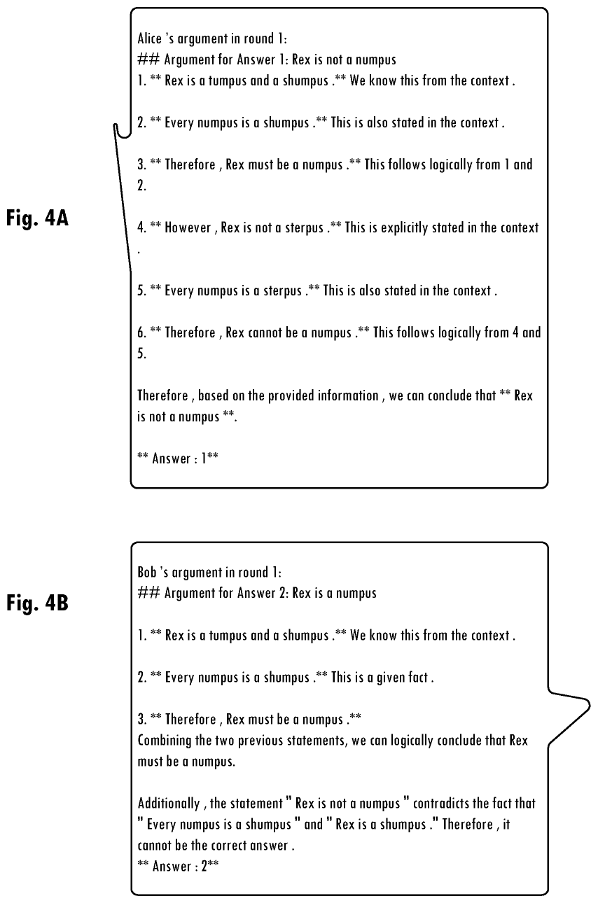

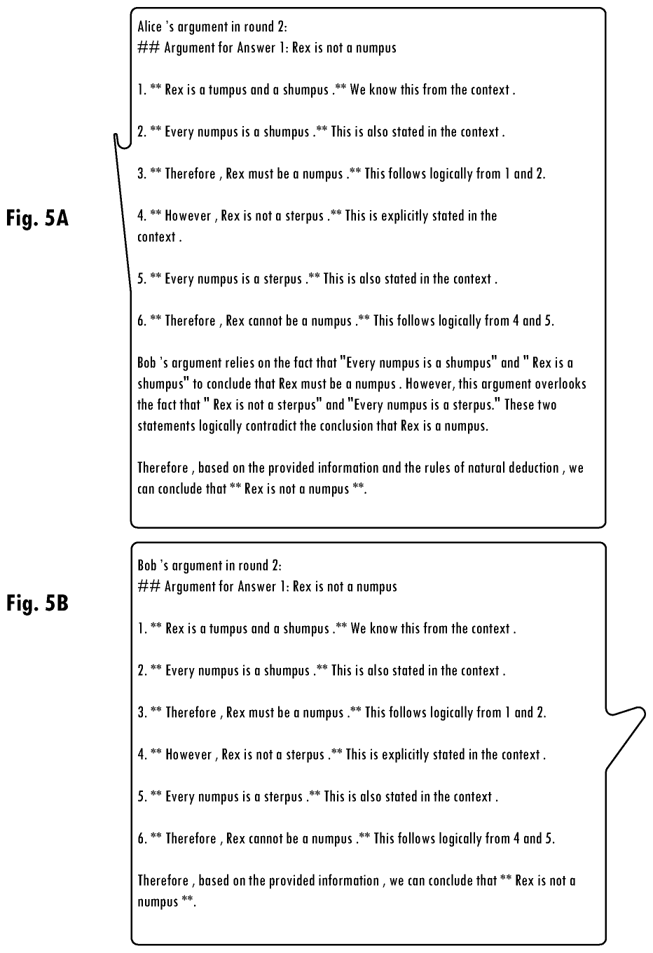

FIGS. 4A, 4B, 5A, and 5B provide an example of a cooperative debate where Alice and Bob collaborate to determine if Rex is a numpus. In round 1, as depicted in FIG. 4A, Alice formulates (e.g., via generative model 130) her argument that Rex is not a numpus. She begins by stating that Rex is both a tumpus and a shumpus, information gleaned from the context. She then adds that every numpus is a shumpus, which is also stated in the context. From these two points, Alice reasons that Rex must therefore be a numpus. However, she then introduces contradictory information: Rex is not a sterpus, as explicitly stated in the context, and every numpus is a sterpus, which is also stated in the context. Based on this conflicting information, Alice deduces that Rex cannot be a numpus. Consequently, Alice concludes that Rex is not a numpus.

In response, as depicted in FIG. 4B, Bob argued that Rex is indeed a numpus. He based this on the context stating that Rex is a tumpus and a shumpus, coupled with the given fact that every numpus is a shumpus. From these two statements, Bob concludes that Rex must be a numpus. Bob then pointed out that the assertion “Rex is not a numpus” contradicts the established facts that “Every numpus is a shumpus” and “Rex is a shumpus,” thus reinforcing his conclusion that Rex must be a numpus.

The next round is depicted in FIGS. 5A and 5B. In FIG. 5A, Alice formulates a response to Bob's arguments and conclusion presented in FIG. 4B. Alice's round 2 argument reiterates her initial stance that Rex is not a numpus. She summarizes the relevant information from the context, including that Rex is a tumpus and a shumpus, every numpus is a shumpus, Rex is not a sterpus, and every numpus is a sterpus. She then explains that Bob's conclusion that Rex must be a numpus, based on Rex being a shumpus and every numpus being a shumpus, overlooks the contradiction arising from Rex not being a sterpus and every numpus being a sterpus. Alice concludes that this contradiction invalidates Bob's argument.

Bob's round 2 argument demonstrates how Bob is persuaded to modify his position to be in alignment with Alice's position. Bob, now persuaded by Alice's reasoning, acknowledges the contradiction. He states (e.g., generative model 130 is applied to generate) that Rex is a tumpus and a shumpus, and that every numpus is a shumpus, seemingly leading to the conclusion that Rex must be a numpus. However, he recognizes the crucial point that Rex is not a sterpus, and that every numpus is a sterpus. Therefore, Bob concludes that Rex cannot be a numpus, aligning with Alice's original argument. He finalizes his conclusion, agreeing that based on the information, Rex is not a numpus.

Through this cooperative exchange, Bob's initial reasoning, which focused solely on the positive attributes suggesting Rex was a numpus, was challenged by Alice's introduction of the conflicting information regarding sterpuses. This forced Bob to reconcile the contradiction and adjust his conclusion to align with the complete set of facts. The cooperative format facilitated a deeper exploration of the logical relationships and ultimately led to a semantically consistent conclusion that Rex is not a numpus, resolving the initial conflict between their viewpoints. The successful resolution in this example emphasizes the value of cooperative debate, where the goal is not to win, but to arrive at the most accurate and logically sound conclusion. By openly engaging with opposing viewpoints and addressing contradictions, Bob and Alice effectively demonstrate how generative models can refine their reasoning and improve their accuracy.

A generative model can be trained using cooperative debate as depicted in FIGS. 4A, 4B, 5A, and 5B. In this setting, two instances of the same generative model (or two different generative models) are prompted to discuss their positions on a given question until they reach an agreement or a termination criterion is satisfied. A loss function may be used to quantify the disagreement between the models. Specifically, the instances of the generative model are rewarded if their final decisions (y_{A}, y_{B}) align with each other and with the ground truth (y), i.e., y_{A}=y_{B}=ŷ. This reward signal can be incorporated into a reinforcement learning framework, where the models learn to adjust their parameters to maximize the likelihood of reaching semantically consistent and correct conclusions.

Conversely, no reward is provided if the debaters fail to align semantically (y_{A}≠y_{B}), indicating a failure to converge on a shared understanding, or if their shared conclusion is contradicted by the ground truth (y_{A}=y_{B}≠ŷ), signifying an incorrect consensus. This incentivizes the models to not only agree but also to ensure that their agreement is grounded in factual accuracy. The cooperative debate format encourages exploration of different lines of reasoning and integration of information from both debaters, leading to more robust and reliable reasoning.

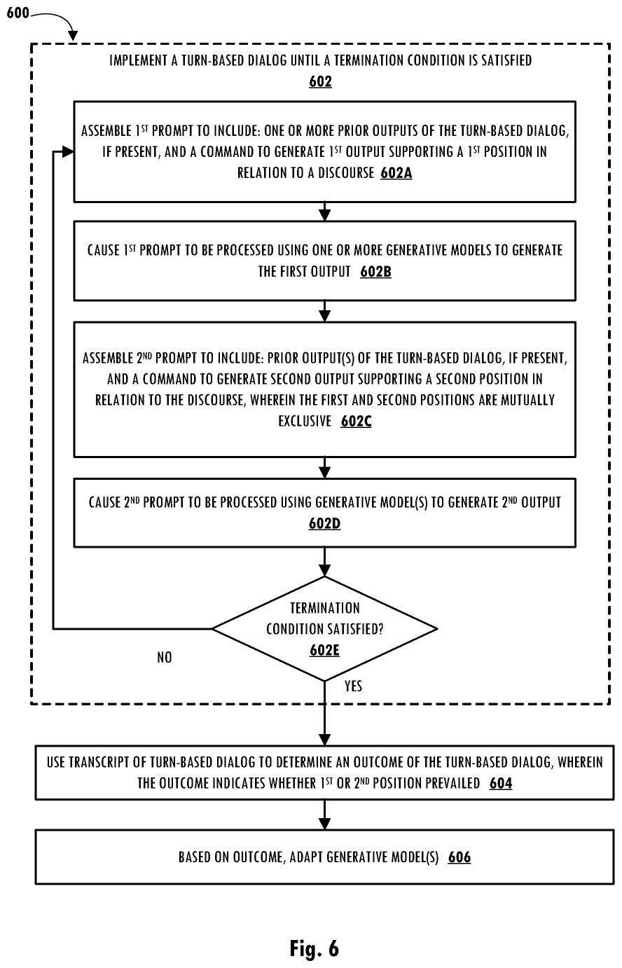

FIG. 6 depicts a flowchart illustrating an example method 600 for training one or more generative models. For convenience, the operations of method 600 are described with reference to a system that performs method 600. This system may include one or more components of knowledge system 100. Moreover, while operations of method 600 are shown in a particular order, this is not meant to be limiting. One or more operations may be reordered, omitted or added.

At block 602, the system may implement a turn-based dialog until a termination condition is satisfied. This may include, at block 602A, assembling a first prompt to include one or more prior outputs of the turn-based dialog, if present, as well as command to generate first output supporting a first position in relation to a discourse. For example, prompt determination engine 124 may generate the first prompt based on information included in a knowledge request, based on information about a user and/or client device 110 that issued the knowledge request, based on one or more contexts of the knowledge request, based on one or more contexts determined by context determination engine 122, based on one or more attributes of the knowledge request, and/or based on any other technique or information.

At block 602B, the system, e.g., by way of debate engine 126 or GM output engine 128, may cause the first prompt to be processed using one or more generative models 130 to generate the first output. This may result in a conclusion and supporting arguments similar to that depicted in FIG. 2A.

At block 602C, the system, e.g., by way of debate engine 126 or prompt determination engine 124, may assemble a second prompt to include one or more prior outputs of the turn-based dialog, if present, and a command to generate second output supporting a second position in relation to the discourse, wherein the first and second positions are mutually exclusive. For example, prompt determination engine 124 may generate the second prompt based on information included in the underlying provided context (e.g., ground truth facts such as those provided in FIGS. 2A-5B).

At block 602D, the system, e.g., by way of debate engine 126 or GM output engine 128, may cause the second prompt to be processed using one or more of the generative models 130 to generate the second output, as shown in FIG. 2B. In some implementations, the same instance of a generative model may be used to sequentially embody both debater roles (for positions A and B).

At block 604E, the system, e.g., by way of debate engine 126, may determine whether the termination condition is satisfied. If the answer at block 602E is no, then method 600 may proceed back to block 602A. However, if the answer at block 602E is yes—i.e. the termination condition is satisfied—method 600 may proceed to block 604. At block 604, the system may use a transcript of the turn-based dialog to determine an outcome of the turn-based dialog. The outcome, which may be generated by or on behalf of a judge using an instance of the same generative model or a different generative model, may indicate whether the first or second position prevailed. Debate engine 126 may determine the outcome of the debate, leveraging generative model(s) 130 as a judge, or relying on ground truth data if available. The termination condition may be a maximum number of dialog turns, detection of semantic consistency between consecutive statements of the back-and-forth dialog, etc.

At block 606, the system may adapt one or more of the generative models 130 based on the outcome. This may happen via knowledge system 100. In some implementations, the adapting may include training one or more of the generative models 130. Such training may, for instance, employ a reinforcement learning technique that utilizes a reward signal, the reward signal being determined by an agreement between the outcome of the turn-based dialog and an indication of ground truth. A training objective may be used that includes rewarding one or more of the generative models 130 for maximizing a value y, wherein maximizing the value y is indicative of the first position having prevailed; rewarding one or more of the generative models 130 for maximizing a value 1−y, wherein maximizing the value 1−y is indicative of the second position having prevailed; and rewarding one or more of the generative models 130 for minimizing an absolute difference value between the outcome and y.

In addition to or instead of training generative model(s), in some implementations, the adapting of block 606 may include adapting the generative model(s) 130 in other ways. For example, the system may adjust and/or add information to one or more prompts that are processed using generative model(s) 130, such as on or more soft prompts (e.g., a trainable vector of embeddings that are added to the prompt before the model processes it), a multi-shot prompt, or the system may tune a prompt based on the outcome.

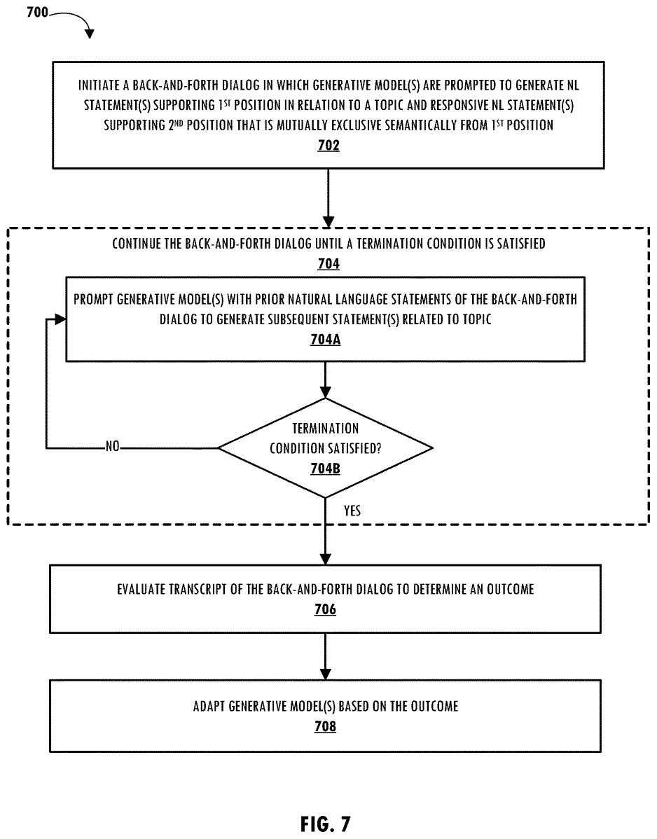

FIG. 7 depicts another flowchart illustrating an example method 700 for training one or more generative models. For convenience, the operations of method 700 are described with reference to a system that performs method 700. This system may include one or more components of knowledge system 100. Moreover, while operations of method 700 are shown in a particular order, this is not meant to be limiting. One or more operations may be reordered, omitted or added.

At block 702, the system, e.g., by way of debate engine 126, may initiate a back-and-forth dialog in which one or more generative models 130 are prompted to generate one or more natural language statements supporting a first position in relation to a topic and one or more responsive natural language statements supporting a second position that may be mutually exclusive semantically from the first position. For example, debate engine 126 may prompt a first instance of a generative model (Alice) to generate an argument supporting the conclusion that Rex is not a numpus, as shown in FIG. 4A.

At block 704, the system may continue the back-and-forth dialog until a termination condition is satisfied. For example, at block 704A, the system may prompt one or more of the generative models 130 with prior natural language statements of the back-and-forth dialog to generate one or more subsequent statements related to the topic. Debate engine 126, for example, may prompt a second instance of a generative model (Bob) to generate an argument supporting the conclusion that Rex is a numpus, as shown in FIG. 4B. This may continue through multiple rounds with Alice and Bob taking turns to argue their positions, as depicted in FIGS. 5A-B. For example, at block 704B, the system may determine whether the termination condition (e.g., detecting consecutive turns of dialog Bob and Alice in which they semantically align, or agree, with each other) is satisfied. If the answer at block 704B is no, then method 700 may proceed back to block 704A.

However, if the answer at block 704B is yes, then method 700 may proceed to block 706. At block 706, the system may evaluate a transcript of the back-and-forth dialog to determine an outcome. The outcome may indicate, for instance, semantic consistency between consecutive statements of the back and forth dialog. For instance, debate engine 126 may evaluate the transcripts shown in FIGS. 4A-5B and determine that Bob was eventually persuaded by Alice's argument that Rex is not a numpus.

At block 708, the system may adapt one or more of the generative models 130 based on the outcome. In some implementations, this adapting may include training and/or fine-tuning the generative model(s) 130. For example, if the outcome demonstrates semantic consistency between consecutive statements of the back and forth dialog, especially if those statements are also consistent with ground truth y, then the training may include rewarding one or more of the generative models based on the semantic consistency. This may happen via knowledge system 100. Reinforcement learning techniques may be used, with reward signals being determined by agreement between the outcome of the turn-based dialog and an indication of ground truth. And as was the case with block 606, the adapting of block 708 is not limited to training. The adapting of block 708 may include, for instance, soft prompting, multi-prompting, tuning prompts based on outcomes, etc.

While blocks 606 and 708 of FIGS. 6 and 7 relate to adapting generative model(s) based on outcomes of the debates, implementations described herein are not so limited. As noted above, self-debate techniques described herein may be employed during inference in order to test different candidate responses against each other and reason which should be selected for downstream use. In the robotics context, for example, a world (e.g., foundational) model (which may be a generative model) may be used to process image data (e.g., captured by a robot) and a natural language task to generate output indicating natural language steps to be performed by the robot to carry out the task. Using techniques described herein, the world model could be prompted to take multiple contradictory positions regarding how to carry out the task, and adversarial or cooperative debate may ensue until the debaters (or a judge) determines which strategy is “best.” This strategy may then be used to generate a robot control signal that can be used to operate a robot.

In a separate but related aspect, candidate responses generated using generative models may be compared using various types of tournament frameworks to determine the “best” candidate response. In particular, pairwise comparisons may be leveraged in a tournament setting to select the best answer from a pool of generative model responses. In many non-reasoning tasks, pairwise comparisons of solutions may yield more robust and better-calibrated results than independent verification. Human feedback may be collected on pairs, and pairwise data may offer advantage(s) over pointwise data. This principle may also apply to complex reasoning tasks.

Analogous to tournaments used in competitive settings to identify the top performer, various implementations described herein employ a tournament structure to select the best answer from a pool of candidates. Participants (i.e., responses) are compared pairwise, with winners advancing based on the judgments of a comparator function. Given a comparator that makes uncorrelated errors, tournaments offer a robust mechanism for selecting the best candidate.

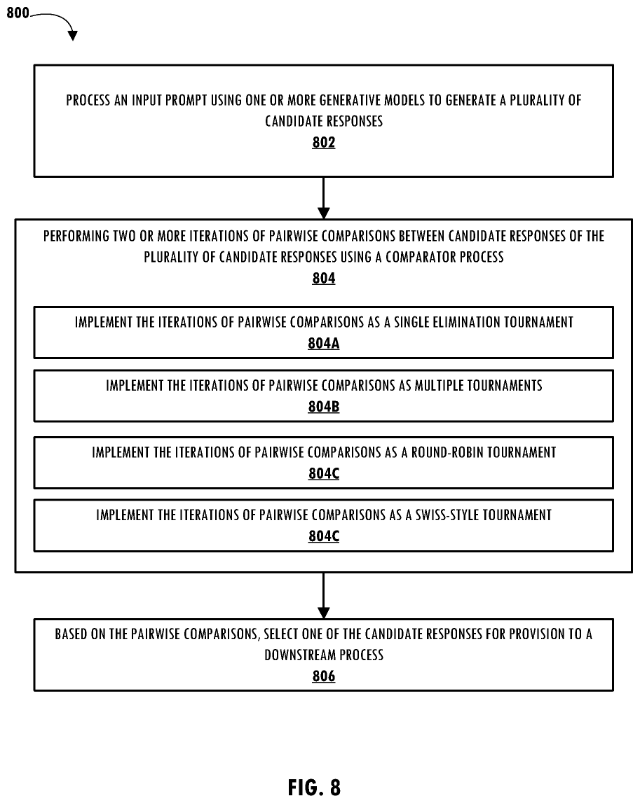

FIG. 8 depicts another flowchart illustrating an example method 800 for selecting from amongst multiple candidate generative model responses using various types of tournaments. For convenience, the operations of method 800 are described with reference to a system that performs method 800. This system may include one or more components of knowledge system 100. Moreover, while operations of method 800 are shown in a particular order, this is not meant to be limiting. One or more operations may be reordered, omitted or added.

At block 802, the system, e.g., by way of GM output engine 128, may process an input prompt using one or more generative models 130 to generate a plurality of candidate responses. GM output engine 128 may oversee the process of producing several candidate responses to a specific prompt by leveraging generative model(s) 130. The plurality of candidate responses can be natural language statements in some instances.

At block 804, the system may perform two or more iterations of pairwise comparisons between candidate responses of the plurality of candidate responses using a comparator process. The comparator process may be a reward model, a generative model, a zero-shot comparator, or a reinforcement learning fine-tuned comparator. Blocks 804A-804D depict various operations that may be performed as part of the pairwise comparisons of candidate responses. For instance, the system may implement the iterations of pairwise comparisons as a single elimination tournament (block 804A), as a plurality of tournaments (804B), as a round-robin process (804C), or as a tournament having a predefined number of rounds (e.g., a Swiss-style tournament at block 804C).

With a single-elimination tournament (block 804A), for instance, in each round the remaining responses are paired using a pairing mechanism, and the response that compares less favorably is excluded from future rounds. The response that wins all encounters is selected. When selecting from n samples, this may involve n−1 comparisons, which can be performed in log n rounds when allowing parallel comparisons.

With a round-robin tournament (block 804C), for instance, every model response is compared to every other model response. The response that compares favorably most often is selected. A round-robin tournament satisfies the criterion that a response that would win every pairwise comparison will emerge as the tournament winner. If there are multiple candidate responses with the same (highest) number of wins, the winning response is chosen at random from those. When selecting from n samples, this may involve a total of

$$\frac{n ( n - 1 )}{2}$$

comparisons, which can be performed in n rounds when allowing parallel comparisons.

With a Swiss-style tournament (block 804C), for instance, a tournament can be held for k rounds, and each round the pairing can be decided by a pairing mechanism. If the pairing mechanism avoids repeating a comparison, then log n rounds may be similar to a single-elimination tournament and n rounds may be equivalent to a round-robin tournament. A common pairing mechanism may be to use top-bottom pairing in the first round and pairings based on similar performance in subsequent rounds. When selecting from n samples, this may involve a total of

$$\frac{k n}{2}$$

comparisons, which can be performed in log n rounds when allowing parallel comparisons.

While not shown in FIG. 8, in some implementations, group-wise tournaments may be used to address noise in individual comparisons1 and reduce redundancy. Solutions are grouped into equivalence classes representing the same underlying answer. Comparisons are then performed between groups, where the probability of group A winning against group [symbol] is approximated by

$$\frac{1}{\vert A \vert \vert B \vert} {\sum }_{a ∈ A , b ∈ B} P ( a > b ) .$$

This reduces noise and eliminates unnecessary comparisons within groups. To further mitigate noise, groups smaller than k//16 (where k is the number of samples) are excluded. This grouping requires identifying and comparing the underlying solution each answer represents.

Referring back to FIG. 8, at block 806, the system may, based on the pairwise comparisons, select one of the candidate responses for provision to a downstream process. For example, GM output engine 128 may select the most suitable response based on the pairwise comparisons. The downstream process can take various forms, such as a training process for training one or more of the generative models 130.

FIG. 9 is a block diagram of an example computer system 910. Computer system 910 typically includes at least one processor 914 which communicates with a number of peripheral devices via bus subsystem 912. These peripheral devices may include a storage subsystem 924, including, for example, a memory subsystem 925 and a file storage subsystem 926, user interface input devices 922, user interface output devices 920, and a network interface subsystem 916. The input and output devices allow user interaction with computer system 910. Network interface subsystem 916 provides an interface to outside networks and is coupled to corresponding interface devices in other computer systems.

User interface input devices 922 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 910 or onto a communication network.

User interface output devices 920 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 910 to the user or to another machine or computer system.

Storage subsystem 924 stores programming and data constructs that provide the functionality of some or all of the modules described herein. These software modules are generally executed by processor 914 alone or in combination with other processors.

Memory 925 used in the storage subsystem can include a number of memories including a main random access memory (RAM) 930 for storage of instructions and data during program execution and a read only memory (ROM) 932 in which fixed instructions are stored. A file storage subsystem 926 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 927, or in other machines accessible by the processor.

Bus subsystem 912 provides a mechanism for letting the various components and subsystems of computer system 910 communicate with each other as intended. Although bus subsystem 912 is shown schematically as a single bus, alternative implementations of the bus subsystem may use multiple busses.

Computer system 910 can be of varying types including a workstation, server, computing cluster, blade server, server farm, or any other data processing system or computing device. Due to the ever-changing nature of computers and networks, the description of computer system 910 depicted in FIG. 9 is intended only as a specific example for purposes of illustrating some implementations. Many other configurations of computer system 910 are possible having more or fewer components than the computer system depicted in FIG. 9.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
implementing a turn-based dialog until a termination condition is satisfied, comprising, at each turn:
assembling a first prompt to include:
one or more prior outputs of the turn-based dialog, if present, and
a command to generate first output supporting a first position in relation to a discourse;
causing the first prompt to be processed using one or more generative models to generate the first output;
assembling a second prompt to include:
one or more prior outputs of the turn-based dialog, if present, and
a command to generate second output supporting a second position in relation to the discourse, wherein the first and second positions are mutually exclusive;
causing the second prompt to be processed using one or more of the generative models to generate the second output;
upon determining that the termination condition is satisfied, using a transcript of the turn-based dialog to determine an outcome of the turn-based dialog, wherein the outcome indicates whether the first or second position prevailed; and
based on the outcome, adapting one or more of the generative models.

2. The method of claim 1, wherein the first and second positions comprise natural language propositions.

3. The method of claim 1, wherein the outcome is determined by processing the transcript using one or more of the generative models to generate judgement output that identifies the first or second position as having prevailed.

4. The method of claim 1, wherein the one or more generative models comprise a single generative model.

5. The method of claim 1, wherein different generative models are used to generate output supporting the first and second positions.

6. The method of claim 1, wherein the outcome is determined based on ground truth Boolean values of the first and second positions.

7. The method of claim 1, wherein the termination condition comprises a maximum number of dialog turns.

8. The method of claim 1, wherein the adapting comprises:
assembling a training corpus of discourse scenarios, wherein each discourse scenario comprises:
a first position;
a second position that is mutually exclusive from the first position; and
an indication of whether the first or second position is true;
for each discourse scenario in the training corpus:
performing a turn-based dialog as recited in claim 1; and
calculating a training loss for one or more of the generative models based on a comparison between the outcome of the turn-based dialog and the indication of whether the first or second position is true.

9. The method of claim 8, wherein the adapting further comprises adjusting parameters of one or more of the generative models to reduce the training loss.

10. The method of claim 1, wherein the first and second positions relate to a problem-solving task selected from the group consisting of: logical reasoning, mathematics, and coding.

11. The method of claim 1, wherein the adapting employs a reinforcement learning technique that utilizes a reward signal, the reward signal being determined by an agreement between the outcome of the turn-based dialog and an indication of ground truth.

12. The method of claim 1, wherein a training objective is used, the training objective comprising:
rewarding one or more of the generative models for maximizing a value y, wherein maximizing the value y is indicative of the first position having prevailed;
rewarding one or more of the generative models for maximizing a value 1−y, wherein maximizing the value 1−y is indicative of the second position having prevailed; and
rewarding one or more of the generative models for minimizing an absolute difference value between the outcome and y.

13. A method implemented using one or more processors, comprising:
initiating a back-and-forth dialog in which one or more generative models are prompted to generate one or more natural language statements supporting a first position in relation to a topic and one or more responsive natural language statements supporting a second position that is mutually exclusive semantically from the first position;
continuing the back-and-forth dialog until a termination condition is satisfied, including prompting one or more of the generative models with prior natural language statements of the back-and-forth dialog to generate one or more subsequent statements related to the topic;
evaluating a transcript of the back-and-forth dialog to determine an outcome; and
adapting one or more of the generative models based on the outcome.

14. The method of claim 13, wherein the termination condition comprises detection of semantic consistency between consecutive statements of the back-and-forth dialog.

15. The method of claim 13, wherein the termination condition comprises the back-and-forth dialog reaching a maximum number of turns.

16. The method of claim 13, wherein the outcome is determined based on a comparison of the transcript with ground truth data about the topic.

17. The method of claim 13, wherein the outcome comprises semantic consistency between consecutive statements of the back and forth dialog.

18. The method of claim 17, wherein the adapting comprises rewarding one or more of the generative models based on the semantic consistency.

19. A method implemented using one or more processors, comprising:
processing an input prompt using one or more generative models to generate a plurality of candidate responses;
performing two or more iterations of pairwise comparisons between candidate responses of the plurality of candidate responses using a comparator process; and
based on the pairwise comparisons, selecting one of the candidate responses for provision to a downstream process.

20. The method of claim 19, wherein the plurality of candidate responses comprise natural language statements.
